(19) United States
(12) Patent Application Publication
(10) Pub. No.: US 2018/0152315 A1
(43) Pub. Date: May 31, 2018

(54) COMMUNICATION SYSTEM

(71) Applicant: HONDA MOTOR CO., LTD., Tokyo (JP)

(72) Inventor: Atsushi Kurauchi, Haga-gun (JP)

(21) Appl. No.: 15/814,471

(22) Filed: Nov. 16, 2017

(30) Foreign Application Priority Data
Nov. 30, 2016 (JP) 2016-232288

(51) Int. Cl. H04L 12/40; B60R 16/023; H04L 29/08

(52) U.S. Cl. CPC H04L 12/40; B60R 16/023; H04L 2012/40273; H04L 2012/40215; H04L 67/12

(57) ABSTRACT

Provided is a communication system including a plurality of communication devices connected to a common communication bus, wherein the plurality of communication devices include at least one set of two authorized communication devices configured to transmit a signal including first identification information and receive a signal including the first identification information.

### CROSS-REFERENCE TO RELATED APPLICATION

Priority is claimed on Japanese Patent Application No. 2016-232288, filed Nov. 30, 2016, the content of which is incorporated herein by reference.

### BACKGROUND OF THE INVENTION

### Field of the Invention

The present invention relates to a communication system.

### Description of Related Art

In recent years, communication systems in which a plurality of communication devices communicate with one another via a network to control various functions have been provided. In such communication systems, technology for reducing the influence of an unauthorized action in a network is known (see, for example, Japanese Unexamined Patent Application, First Publication No. 2014-11621 (hereinafter referred to as Patent Literature 1)).

Patent Literature 1 discloses that a vehicle communication system including a communication path and a plurality of electronic control units (ECUs) connected to the communication path detects unauthorized communication.

### SUMMARY OF THE INVENTION

However, according to Patent Literature 1, there is a problem that if the communication signal is illegally acquired, the communication signal cannot be concealed even if unauthorized communication can be detected.

An aspect of the present invention has been made in consideration of such circumstances, and an objective of the present invention is to provide a communication system that makes it possible to conceal a communication signal with a simpler configuration.

To solve the above-described problem, the present invention adopts the following aspects.

(1) A communication system according to an aspect of the present invention is a communication system including a plurality of communication devices connected to a common communication bus, wherein the plurality of communication devices include: at least one set of two authorized communication devices configured to transmit a signal including first identification information and receive a signal including the first identification information.

According to the aspect (1), the communication devices provided in the communication system include at least the two authorized communication devices. The two authorized communication devices transmit the signal including the first identification information and receive the signal including the first identification information.

(2) In the aspect (1), the communication devices belonging to the set may transmit the signal including the first identification information and receive the signal including the first identification information if communication from an external device different from the communication devices connected to the common communication bus is detected.

(3) In the aspect (1) or (2), the number of sets may be increased if communication from an external device different from the communication devices connected to the common communication bus is detected.

(4) In any one of the aspects (1) to (3), the communication devices belonging to the set may transmit information of different properties as the signal including the first identification information.

(5) In any one of the aspects (1) to (4), communication devices belonging to a plurality of different sets may use the first identification information differing according to each belonging set.

(6) In any one of the aspects (1) to (5), the first identification information may indicate that the signal including the first identification information should be received.

(7) In any one of the aspects (1) to (6), the first identification information may indicate a transmission source of the transmitted signal.

(8) In any one of the aspects (1) to (7), the first identification information may be associated with information related to a control operation.

(9) In any one of the aspects (1) to (8), a property of information to be transmitted by one communication device belonging to the set as the signal including the first identification information may be different from a property of information to be received by the communication device as the signal including the first identification information.

According to an aspect of the present invention, there is provided a communication system in which a plurality of communication devices are provided in one communication network, wherein the plurality of communication devices include at least one set of two authorized communication devices configured to transmit a signal including first identification information and receive a signal including the first identification information. Thereby, because it is difficult to identify a device transmitting the signal including the first identification information or identify a property or type of information transmitted by the signal including the first identification information from the point of view of a device which is not a communication device belonging to the set or a third party, it is possible to conceal a communication signal with a simpler configuration.

### BRIEF DESCRIPTION OF THE DRAWINGS

FIG. 1 is a diagram illustrating a configuration of a communication system 1 according to a first embodiment.

FIG. 2 is a diagram illustrating a hardware configuration of an ECU 10 according to the present embodiment.

FIG. 3 is a diagram illustrating a functional configuration of an ECU 10 according to the present embodiment.

FIG. 4 is a diagram illustrating a process of concealing a communication signal according to the present embodiment.

FIG. 5 is a diagram illustrating an example of communication according to the present embodiment.

FIG. 6 is a flowchart illustrating a procedure of a process of selectively performing a concealment process according to a second embodiment.

FIG. 7 is a diagram illustrating an example of communication according to the present embodiment.

FIG. 8 is a flowchart illustrating a procedure of a second process of selectively performing a concealment processing according to a third embodiment.

FIG. 9 is a diagram illustrating an example of communication according to the present embodiment.

### DETAILED DESCRIPTION OF THE INVENTION

Hereinafter, an embodiment of a communication system of the present invention will be described with reference to the drawings.

### First Embodiment

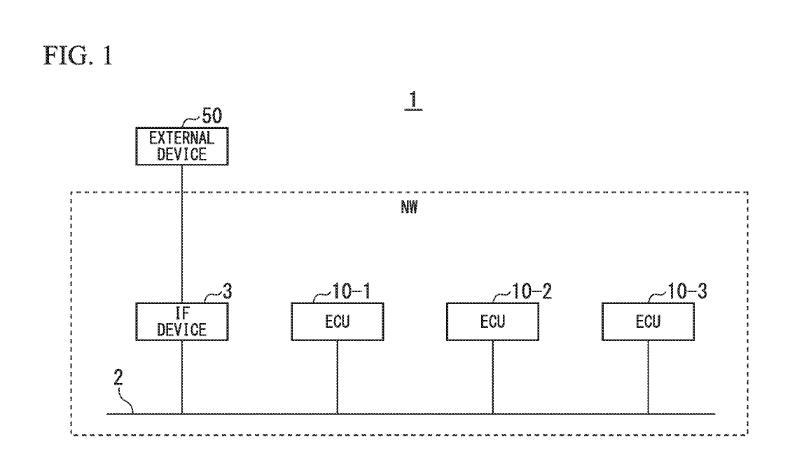

FIG. 1 is a diagram illustrating a configuration of a communication system 1 according to the present embodiment. The communication system 1 is mounted on, for example, a vehicle. The communication system 1 constitutes at least a network NW in the vehicle. In the network NW, for example, communication based on a controller area network (CAN) and a communication scheme such as IEEE 802.3 is performed via a bus 2 (a communication bus).

The communication system 1 includes ECUs 10-1 to 10-3 connected to the bus 2.

Hereinafter, if the ECUs 10-1 to 10-3 are not distinguished from one another, they are simply referred to as an ECU 10. Although devices such as the ECUs 10-1 to 10-3 will be described as control devices for controlling a device of the vehicle, they may be relay devices having a signal relaying function. Also, although the devices such as the ECUs 10-1 and 10-3 and the like will be described as being connected to the common bus 2, the devices may be connected to different buses so that they are connected to communicate with each other through a relay device (not illustrated) or the like configured to transfer identification information included in the received signal to a transfer destination without rewriting the identification information.

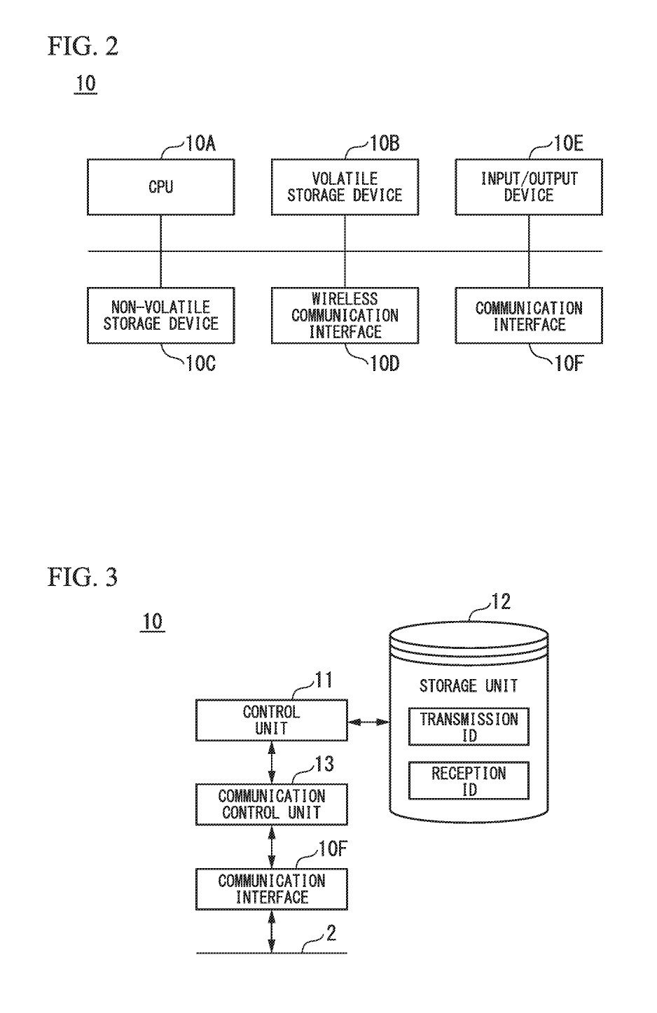

The ECU 10 is, for example, an engine ECU configured to control an engine, a seat belt ECU configured to control a seat belt, or the like. The ECU 10 receives a frame transmitted to a network NW to which the ECU 10 belongs. Hereinafter, each frame transmitted to the network NW is referred to as a frame F. The frame F is identified by an identifier (hereinafter referred to as ID) attached thereto. The ECU 10 stores an ID (hereinafter referred to as reception ID) for identifying the frame F related to the ECU 10 in the storage unit 12 (FIG. 2B). When the frame F is received, the ECU 10 refers to the ID attached to the received frame F (hereinafter referred to as a transmission ID) and extracts and acquires the frame F to which the transmission ID having the same value as the reception ID is attached. The ECU 10 performs a process of authenticating a communication partner when communication is performed.

In the network NW, an interface device (an IF device) 3 for connecting an external device 50 such as a verification device is provided. For example, the IF device 3 has a connection terminal (a diagnostic logic connector (DLC)) for communicating with the external device 50 by using a wired link or a wireless communication unit for communicating with the external device 50 by using a wireless link. A verification device or the like connected to the IF device 3 at the time of vehicle inspection or the like is an example of the external device 50. The verification device communicates with the ECU 10 connected to the bus 2 to inspect and verify the state of the communication system 1. It is possible to cause the communication system 1 to function without connecting a verification device or the like to the IF device 3 except for at a vehicle inspection time or the like.

FIG. 2 is a diagram illustrating a hardware configuration of the ECU 10 according to this embodiment. The ECU 10 is a computer including a CPU 10A, a volatile storage device 10B such as a random access memory (RAM) or a register, a nonvolatile storage device 10C such as a read only memory (ROM), an electrically erasable and programmable read only memory (EEPROM), or a hard disk drive (HDD), a wireless communication interface 10D, an input/output device 10E, a communication interface 10F, and the like. Also, according to a type or application of the ECU 10, the ECU 10 may not include either or both of the wireless communication interface 10D and the input/output device 10E.

FIG. 3 is a diagram illustrating a functional configuration of the ECU 10 according to this embodiment. The ECU 10 includes a control unit 11, a storage unit 12, and a communication control unit 13. For example, the control unit 11, the communication control unit 13, and a code generation unit 14 are implemented by a processor such as the CPU 10A executing a program.

The control unit 11 controls each part including the communication control unit 13. For example, the control unit 11 receives communication requests from other devices such as another ECU 10, the IF device 3, and the external device 50. For example, the communication request has a communication signal concealed by the following method.

The storage unit 12 is implemented by the volatile storage device 10B and the nonvolatile storage device 10C. The storage unit 12 stores a program such as an application program or a communication control program and various types of information to be referred to by execution of the above-described program. The various types of information include a transmission ID and a reception ID.

The communication control unit 13 controls communication with an external device via the communication interface 10F. The communication interface 10F is an interface for connecting the ECU 10 to the bus 2.

The communication control unit 13 controls the communication interface 10F to enable communication with other devices requested by the control unit 11. The communication control unit 13 receives the notification from the communication interface 10F and notifies the control unit 11 of a communication request from another device. Approval or rejection for a communication request from another apparatus is determined in an authentication process or the like in the control unit 11.

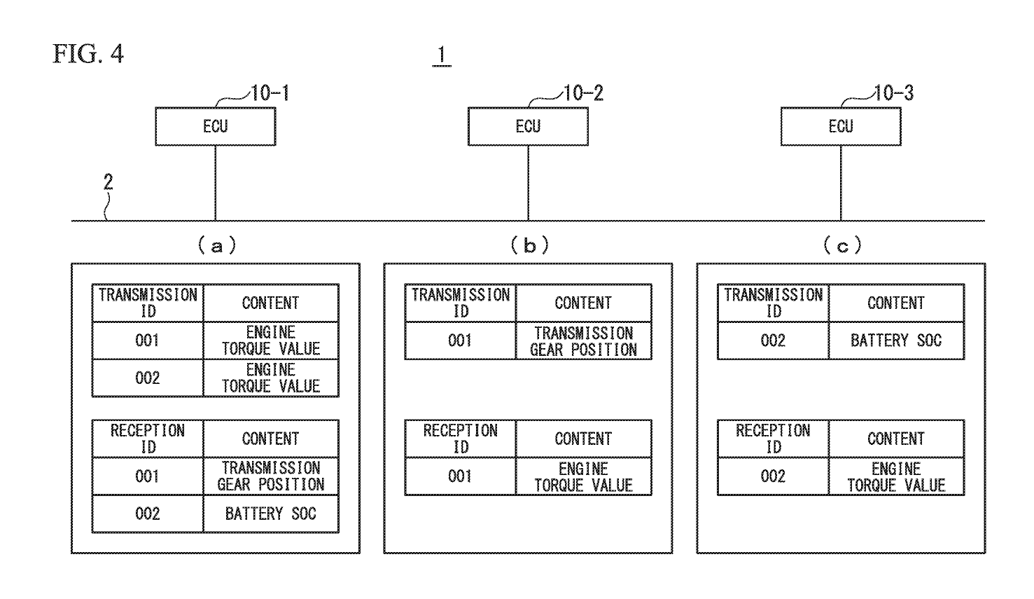

Next, a more specific example will be shown. FIG. 4 is a diagram illustrating a process of concealing a communication signal according to the present embodiment.

For example, each ECU 10 is allocated to the following applications.

The ECU 10-1 transmits commands directed to the ECU 10-2 and the ECU 10-3.

For example, the ECU 10-2 controls a transmission provided in correspondence with the command received from the ECU 10-1 or the like on the basis of the command received from the ECU 10-1 or the like. The ECU 10-2 transmits a response to the command to the ECU 10-1.

For example, the ECU 10-3 adjusts a state of charge (SOC) of a battery provided in correspondence with the command received from the ECU 10-1 or the like on the basis of the command received from the ECU 10-1 or the like. The ECU 10-3 transmits a response to the command to the ECU 10-1.

FIG. 3 illustrates an example of identification information assigned to each ECU 10. The transmission ID illustrated in FIG. 3 is used when a frame is transmitted and indicates a transmission source of a frame. The reception ID is used when the ID (the transmission ID) assigned to the frame is collated and used to identify the frame to be received. The control unit 11 collates the transmission ID (the identification information) assigned to the frame acquired from the bus 2 with the reception ID stored in the storage unit 12, thereby performing a process of authenticating the acquired frame. If the IDs match each other, the control unit 11 determines that the frame should be received as a frame transmitted from an authorized transmission source.

As illustrated in FIG. 4(a), in the identification information assigned to the ECU 10-1, “001” and “002” are included in the transmission ID and “001” and “002” are included in the reception ID. In the above-described case, the ECU 10-1 selectively uses the two types of transmission IDs according to the application, assigns a transmission ID suitable for the application to the frame, and transmits the frame. For example, a case in which “001” is used in the transmission ID in the ECU 10-1 is a case in which a torque value of the engine is indicated to the ECU 10-2. A case in which “002” is used in the transmission ID is a case in which the torque value of the engine is indicated to the ECU 10-3.

As illustrated in FIG. 4(b), the identification information assigned to the ECU 10-2 includes “001” in the transmission ID and includes “001” in the reception ID. For example, a case in which “001” of the transmission ID is used is a case in which a notification of a transmission gear position is provided to the ECU 10-1.

As illustrated in FIG. 4(c), the identification information assigned to the ECU 10-3 includes “002” in the transmission ID and includes “002” in the reception ID. For example, a case in which “002” of the transmission ID is used is a case in which a notification of the SOC value of the battery is provided to the ECU 10-1.

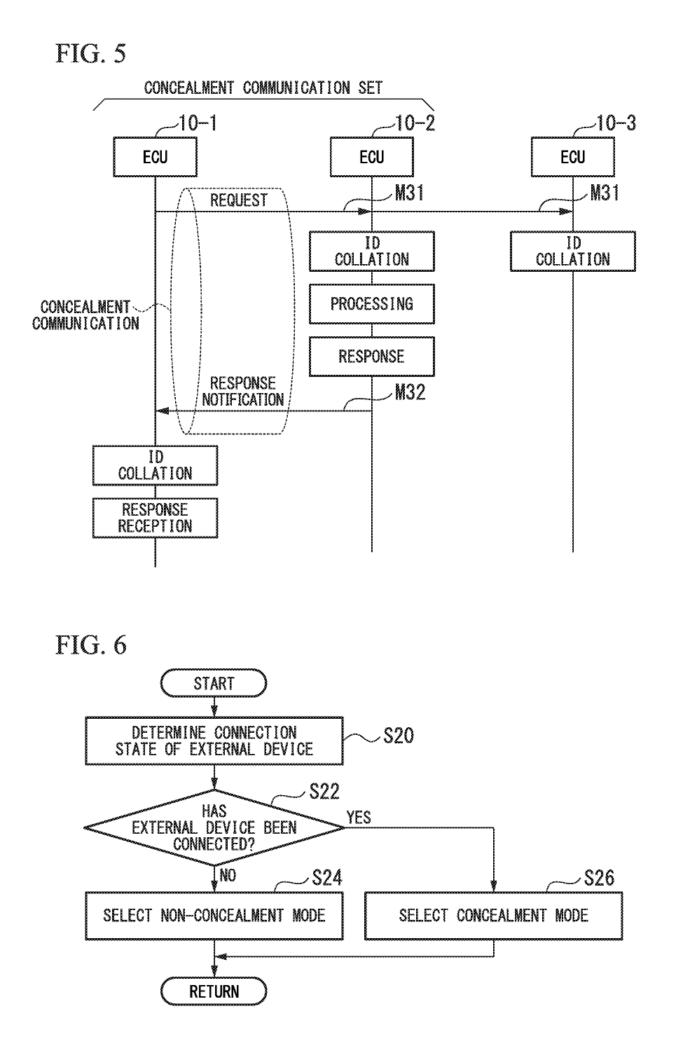

FIG. 5 is a diagram illustrating an example of communication according to the present embodiment.

As illustrated in FIG. 5, for example, when the ECU 10-1 transmits the frame M31 (a signal) including the transmission ID “001” (first identification information), the ECU 10-2 having the reception ID “001” acquires the frame M31 including the transmission ID “001.” The ECU 10-2 collates the transmission ID “001” with the above-described reception ID, and performs a process in accordance with the information transmitted from the ECU 10-1 when it is determined that they match. The ECU 10-2 transmits a response notification for the reception of the above-described frame M31 to the ECU 10-1.

Here, the ECU 10-2 performs communication using the frame M32 to which the transmission ID “001” is assigned when the response notification is transmitted. The ECU 10-1 having acquired the above-described frame M32 uses the reception ID “001” to collate the transmission ID “001” of the acquired frame M32 therewith. On the other hand, the ECU 10-3 not having the reception ID “001” discards the frame M31 including the transmission ID “001” without receiving the frame M31.

Although the above is a case in which the ECU 10-1 uses the transmission ID “001” (first identification information), the same is also true for a case in which the ECU 10-1 uses the transmission ID “002” (first identification information). In the latter case, when the ECU 10-1 transmits a frame (signal) including the transmission ID “002,” the ECU 10-3 receives the frame and the ECU 10-2 discards the frame.

As described above, the communication system 1 includes a set of ECUs 10 (ECUs 10-1 and 10-2) as two authorized communication devices using the predetermined identification information (for example, ID “001”) as the transmission ID and using the identification information (ID “001”) as the reception ID.

A transmission ID assigned to a frame of a communication system as a comparative example is often allocated to uniquely identify the device having transmitted the frame. That is, in the above case, transmission IDs of different devices are determined not to be the same value.

According to the embodiment, in the communication system 1, a plurality of ECU 10 include a set of two ECUs 10 as authorized communication devices configured to transmit a frame including a transmission ID (first identification information) and receive a frame including the transmission ID (the first identification information). Thereby, in the bus 2 of the communication system 1, frames with the same transmission ID are transmitted from different ECUs 10. As a result, it is difficult to identify a property of a signal to which identification information is attached (a type of device serving as a transmission source or a type of information to be transmitted) from the point of view of another device not belonging to the set or a third party even if the transmission ID assigned to the frame is referred to and it is possible to conceal and communicate the information as described above.

Also, as described above, the authorized ECU 10 includes the control unit 11 configured to transmit a frame (a transmission signal) including the transmission ID (the first identification information) and receive the frame (a reception signal) including the above-described transmission ID transmitted from another authorized ECU 10. In the communication between the authorized ECUs 10, these frames can be received without discarding them.

Also, according to the embodiment, the two authorized ECUs 10 transmit information of different properties as frames including the same transmission ID and information of different properties is transmitted in frames having the same transmission ID on the bus 2 and the information of the different properties can be concealed and communicated.

Also, according to the embodiment, even if the ECUs 10 belonging to a plurality of different sets transmit information of the same property to the plurality of ECUs 10 by using a transmission ID differing according to each belonging set, it is possible to perform a control process of causing signals, which are transmitted by the units themselves to a pair of communication devices of each set, to be appropriately received and it is possible to conceal properties of the signals with respect to a communication device and/or a third party not belonging to the set.

Also, according to the embodiment, the transmission ID indicates that a frame including the transmission ID should be received. Thereby, the ECU 10 can select and receive the frame by collating the transmission ID assigned to the received frame.

Also, according to the embodiment, the transmission ID indicates the transmission source of the transmitted frame. Thereby, the ECU 10 can select and receive the frame by collating the transmission ID of the transmitted frame with the reception ID stored in the storage unit 12.

In this case, the above-described collation and selection processes may be performed by the control unit 11, or may be performed by the IF device 3 or the like configured to relay or monitor a frame.

Also, according to the embodiment, the transmission ID is associated with information about the control operation.

Thereby, the ECU 10 can transmit information about a control operation in correspondence with the transmission ID. For example, the information about the control operation may include a detection value, a state value, and a control command value for determining the control operation.

Also, according to the embodiment, for the transmission ID, information of different properties may be allocated to information to be transmitted by one ECU 10 and information to be received thereby. Thereby, the ECU 10 can conceal and communicate information having different properties.

Also, the two authorized ECUs 10 belonging to one set may have a relation in which they mutually perform cooperative control so that a state of a control target device of the other ECU 10 is controlled in accordance with a state of a control target device of one ECU 10. For example, an engine ECU (the ECU 10-1) for controlling the state of the engine and a transmission ECU (the ECU 10-2) for controlling the state of the transmission are designated as a set and transmit and receive signals using common identification information (ID “001”). In this case, a signal of information indicating the state (for example, an output torque) of the engine controlled by the engine ECU is transmitted as ID “001” from the engine ECU and the transmission ECU receiving the signal of ID “001” controls the state of the transmission (for example, a gear stage) in accordance with state information of the engine indicated by the signal. On the contrary, a signal of information indicating the state (for example, a gear stage) of the transmission controlled by the transmission ECU is transmitted as the same ID “001” from the transmission ECU and the engine ECU configured to receive the signal of the ID “001” controls the state (for example, an output torque) of the engine in accordance with state information of the transmission indicated by the signal. As described above, by designating ECUs 10 closely related to each other so that cooperative control is mutually performed as one set, it is possible to appropriately control the other control target device in accordance with the state of one control target device and appropriately prevent an unauthorized action capable of threatening cooperative control of two devices by concealing the signal used at that time.

### Modified Example of First Embodiment

A modified example will be described. In the embodiment, an example in which the transmission ID assigned to the frame is used as the identification information has been described. Instead of this, the ECU 10 of the modified example may use the identification information allocated in data that is stored and transmitted in the frame instead of the identification information (the transmission ID) assigned to the frame. In this case, identification information having a relationship similar to the relationship between the transmission ID and the reception ID of the embodiment may be allocated in the above-described data.

### Second Embodiment

A second embodiment will be described. In the first embodiment, an example (a concealment process) in which a frame including a transmission ID is transmitted and a signal including the transmission ID is received has been described. Instead of this, in the present embodiment, an example in which the concealing process is selectively performed will be described.

The IF device 3 in the communication system 1 detects a state in which communication with the external device 50 is possible and notifies the ECU 10 of the detected state. For example, thereafter, the IF device 3 relays communication between the external device 50 and the ECU 10. The IF device 3 detects a state in which communication with the external device 50 is not performed and notifies the ECU 10 of the state.

Also, the IF device 3 may perform communication by using either a wired link or a wireless link as a communication link with the external device 50. For example, if the IF device 3 and the external device 50 are connected via the wired link, the IF device 3 may detect that the external device 50 is connected to the DLC, or that the external device 50 is disconnected from the DLC and may notify the ECU 10 of the detection of the connection or the disconnection.

For example, if the IF device 3 and the external device 50 are connected via a wireless link, the IF device 3 may detect a state in which communicating with the external device 50 is possible and detect a state in which communication with the external device 50 is not possible and notify the ECU 10 of the detection of communication being possible or not possible. In the following description, an example in which the communication link between the IF device 3 and the external device 50 is a wired link will be described.

FIG. 6 is a flowchart illustrating a procedure of a process of selectively performing a concealment process according to the present embodiment.

First, the control unit 11 detects a connection state of the external device 50 (S20).

For example, the control unit 11 detects a connection of the external device 50 by any one of the following methods.

<Method 1: Determination Based on Information of Notification from IF Device 3>

As described above, if the communication link between the IF device 3 and the external device 50 is a wired link, the IF device 3 detects that the external device 50 is connected to the DLC and that the external device 50 is disconnected from the DLC and notifies the ECU 10 of the connection or the disconnection. In accordance with these notifications, the control unit 11 indirectly detects that the external device 50 is in a connected state.

### <Method 2: Determination Based on Result of Determining Frame to be Communicated Via Bus 2>

The ECU 10 is connected to the bus 2 and can monitor (monitor) a frame to be communicated via the bus 2. The control unit 11 constantly monitors frames being communicated via the bus 2 and detects that there is a frame (an unauthorized frame) being communicated under a condition different from that of a frame from an authorized ECU 10 among the frames. If there is an unauthorized frame, the connection of the external device 50 is detected by estimating that there is a possibility that the external device 50 is in the connected state.

The above-described communication in a “condition different from that of the frame from the authorized ECU 10” is, for example, communication in which any one of the following states is observed.

(1) A state in which, if a frame is transmitted at a fixed cycle, a transmission cycle has a deviation of a predetermined value or more from a standard value of the fixed cycle.

(2) A state in which a frame transmission frequency or the number of frame transmissions has a deviation of a predetermined value or more from a standard value.

(3) A state in which, if the frame is transmitted with a fixed data length (or frame size), its data length (or frame size) is different from a standard value.

(4) A state in which data prohibited from being included and transmitted in the frame is being transmitted.

(5) A state in which another ECU 10 detects a state of the above-described (1) to (4) and a notification indicating that this state has been detected is received from the other ECU 10.

Next, the control unit 11 determines whether or not the external device 50 is connected according to the above-described detection result (S22). If the external device 50 is not connected, the control unit 11 selects a non-concealment mode (S24) and completes the detection process illustrated in FIG. 6. If the external device 50 is connected, the control unit 11 selects a concealment mode (S26) and completes the detection process illustrated in FIG. 6.

Also, the non-concealment mode is a mode in which a transmission ID is allocated to each communication device such as the ECU 10 so that only one ECU 10 transmitting a frame including any transmission ID exists in the network NW. The mode can be expressed as a mode in which the transmission ID is allocated to each communication device such as the ECU 10 so that a frame including the same transmission ID is not received besides its own transmitted frame.

The concealment mode is a mode different from the above-described non-concealment mode, and, is for example, a mode in which communication is performed by the method shown in the first embodiment.

Thereafter, the control unit 11 performs communication in accordance with the mode selected in the above-described detection process.

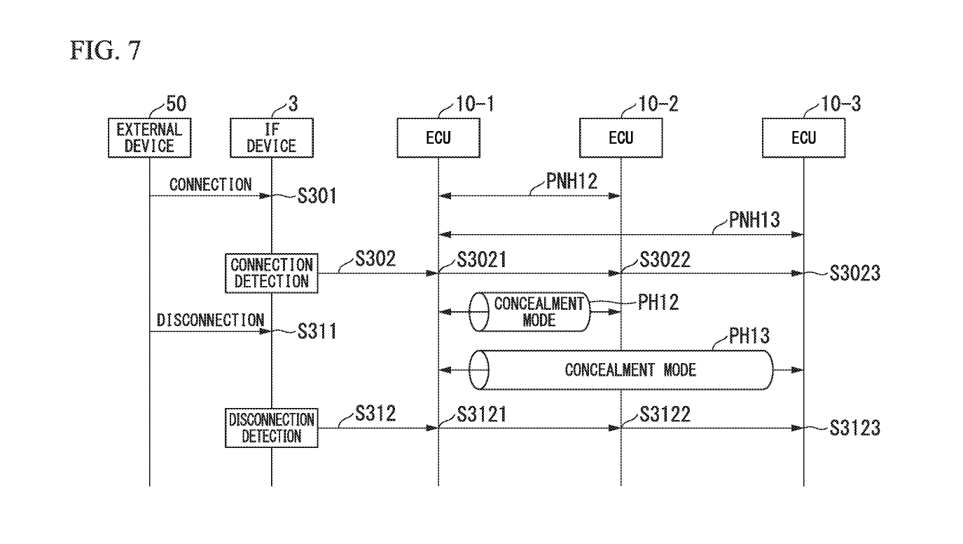

FIG. 7 is a diagram illustrating an example of communication according to the present embodiment.

As illustrated in FIG. 7, for example, the ECU 10-1 and the ECU 10-2 form a first set, the ECU 10-1 and the ECU 10-3 form a second set, and they communicate with each other.

First, the first set performs communication in the non-concealment mode (PNH12) and the second set performs communication in the non-concealment mode (PNH13).

The IF device 3 detects that the external device 50 is connected (S302) according to the connection of the external device 50 (S301) and notifies each ECU 10 of the connection of the external device 50. The ECU 10-1 receives the notification (S3011) and causes the communication to transition to the concealment mode. The ECU 10-2 receives the notification (S3012) and causes the communication to transition to the concealment mode. The ECU 10-3 receives the notification (S3013) and causes the communication to transition to the concealment mode. Thereby, the communication (PH12) of the first set and the communication (PH13) of the second set are in the concealment mode.

The IF device 3 detects that the external device 50 is disconnected (S312) according to the disconnection of the external device 50 (S311) and notifies each ECU 10 of the connection of the external device 50. The ECU 10-1 receives the notification (S3111) and causes the communication to transition to the non-concealment mode. The ECU 10-2 receives the notification (S3112) and causes the communication to transition to the non-concealment mode. The ECU 10-3 receives the notification (S3113) and causes the communication to transition to the non-concealment mode. Thereby, the communication (PNH12) of the first set and the communication (PNH13) of the second set are in non-concealment mode.

As described above, when the IF device 3 detects a connection and a disconnection of the external device 50, the communication system 1 bundles two pairs each having the two authorized ECUs 20 together and controls each ECU 10 so that a concealment process is selectively performed.

According to the above-described second embodiment, in addition to achieving effects similar to those of the first embodiment, the plurality of ECUs 10 include at least one set of two authorized ECUs 20 configured to transmit a frame including a changed transmission ID instead of the transmission ID and receive a signal including the transmission ID if communication from the external device 50 different from the ECU 10 is detected, so that the concealment process can be selectively performed.

Thereby, as compared with the case in which the concealment mode is constantly used, it is possible to improve a concealment property of communication under control according to a case in which a vehicle is used by selectively using the concealment mode.

### Third Embodiment

The third embodiment will be described. In the second embodiment, an example in which a concealment process is selectively performed has been described. Instead of this, in the present embodiment, an example in which the number of sets of ECUs that selectively perform the concealment process is adjusted will be described.

The IF device 3 in the communication system 1 detects a state in which the communication with the external device 50 is possible, notifies the ECU 10 of the detected state, and then relays communication of the external device 50 and the ECU 10. The IF device 3 detects a state in which communication with the external device 50 is not performed and notifies the ECU 10 of the detected state.

The external device 50 designates a set of ECUs 10 that start concealment communication in a state in which communication with the ECU 10 is possible via the IF device 3 and causes the ECUs 10 of the set to set the concealment communication. Thereafter, the ECU 10 of the above-described target set performs communication in a concealment state. The external device 50 releases the concealment state of the communication with the ECU 10 of the above-described target set with respect to the set of the ECUs 10 configured to perform the communication in the concealment state. Thereafter, the ECU 10 of the above-described target set performs the communication in a non-concealment state.

As described above, the communication system 1 independently switches between setting and release of the concealment communication of the set of ECUs 10 for each set.

In addition to a process (a first process) of selectively performing the concealment process illustrated in FIG. 6, the control unit 11 of the embodiment performs the following process.

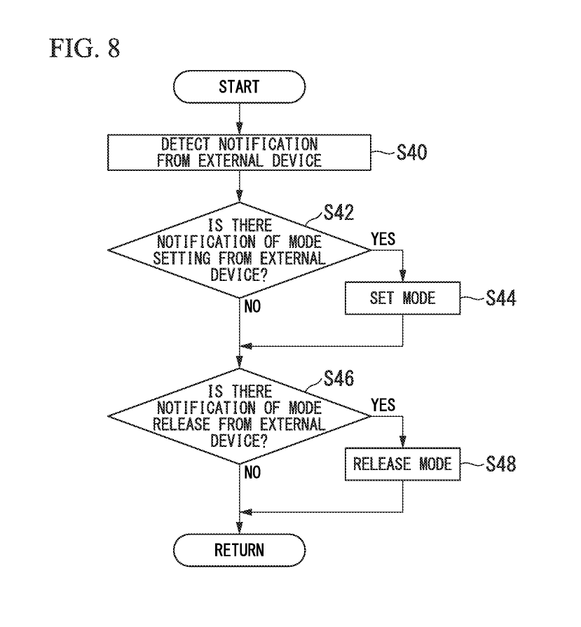

FIG. 8 is a flowchart illustrating a procedure of a second process of selectively performing a concealment process according to the present embodiment. In addition to the above-described process (first process) of selectively performing the concealment process illustrated in FIG. 6, the control unit 11 performs the following process.

First, the control unit 11 detects a notification from the external device 50 (S40). Next, the control unit 11 determines whether or not the detected notification is for setting the concealment communication (S42). If it is determined that the detected notification is for setting the concealment communication, the control unit 11 sets concealment communication for a predetermined set corresponding to the notification (S44).

Next, if it is determined that the detected notification is not for setting the concealment communication or after the processing of S44 is completed, the control unit 11 determines whether or not the detected notification is for releasing the concealment communication (S46). If it is determined that the detected notification is for releasing the concealment communication, the control unit 11 releases the concealment communication with respect to a predetermined set corresponding to the notification (S48). If it is determined that the detected notification is not for releasing the concealment communication or after the processing of S48 is completed, the control unit 11 completes the detection process illustrated in FIG. 8.

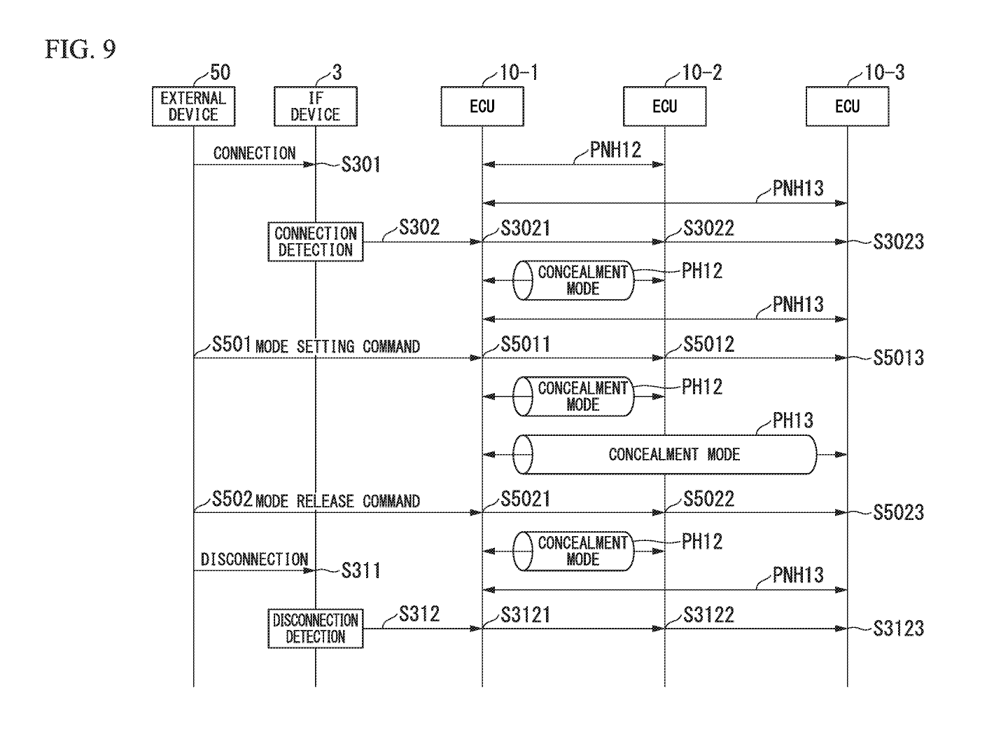

FIG. 9 is a diagram illustrating an example of communication according to the present embodiment.

As illustrated in FIG. 9, for example, the ECU 10-1 and the ECU 10-2 form a first set, the ECU 10-1 and the ECU 10-3 form a second set, and they performs communication with each other.

First, the first set performs communication in the non-concealment mode (PNH12) and the second set performs communication in the non-concealment mode (PNH13).

The IF device 3 detects that the external device 50 is connected (S302) according to the connection (S301) and notifies each ECU 10 of the connection of the external device 50. The ECU 10-1 receives the notification (S3011) and causes communication of the first set to transition to the concealment mode. The ECU 10-2 receives the notification (S3012) and causes the communication of the first set to transition to the concealment mode. The ECU 10-3 discards the notification (S3013). Thereby, the communication (PH12) of the first set is in the concealment mode. The communication (PNH13) of the second set is maintained in the non-concealment mode as it is.

The communication system 1 increases the number of sets if communication from an external device 50 different from the ECU 10 provided in the bus 2 is detected.

Thereby, the communication system 1 performs the communication of the first set in the concealment mode.

The external device 50 notifies each ECU 10 of a concealment mode setting instruction for causing the communication mode to transition from the non-concealment mode to the concealment mode (S501). The ECU 10-1 receives the notification (S5011) and causes the communication of the second set to transition to the concealment mode. The ECU 10-2 discards the notification (S5012). The ECU 10-3 receives the notification (S5013) and causes the communication of the second set to transition to the concealment mode. Thereby, the communication (PH13) of the second set is in the concealment mode, and a concealment mode set (the second set) is added.

If a command (communication) is detected from the external device 50 different from the ECU 10 provided in the bus 2, the communication system 1 increases the number of sets thereof, so that both communication of the first set and communication of the second set are performed in the concealment mode.

The external device 50 notifies each ECU 10 of a concealment mode release command for causing the communication mode to transition from the concealment mode to the non-concealment mode (S502). The ECU 10-1 receives the notification (S5021) and causes the communication of the second set to transition to the non-concealment mode. The ECU 10-2 discards the notification (S5022). The ECU 10-3 receives the notification (S5023) and causes the communication of the second set to transition to the non-concealment mode. Thereby, the communication (PNH13) of the second set is in the non-concealment mode and the second set is excluded from among the sets in which communication is performed in the concealment mode.

The IF device 3 detects that the external device 50 is disconnected (S312) according to the disconnection (S311) and notifies each ECU 10 of the connection of the external device 50. The ECU 10-1 receives the notification (S3111) and causes the communication to transition to the non-concealment mode. The ECU 10-2 receives the notification (S3112) and causes the communication to transition to the non-concealment mode. The ECU 10-3 receives the notification (S3113) and causes the communication to transition to the non-concealment mode. Thereby, the communication (PNH12) of the first set and the communication (PNH13) of the second set are in the non-concealment mode.

In this manner, the IF device 3 detects the connection and the disconnection of the external device 50, so that the communication system 1 controls each ECU 10 so that a concealment process is selectively performed in the first set, which is a set of two authorized ECUs 20.

Furthermore, the communication system 1 controls each ECU 10 so that the concealment process is selectively performed in the second set, which is a set of two authorized ECUs 20, by detecting a command from the external device 50.

According to the third embodiment described above, in addition to achieving effects similar to those of the first embodiment, any one of the plurality of ECUs 10 in the communication system 1 transmits a frame including a changed transmission ID by making a change from a previous transmission ID to a predetermined transmission ID if a command from the external device 50 different from the ECU 10 is detected. Along with this, the communication system 1 can selectively perform the concealment process by providing at least one set of two authorized ECUs 20 configured to receive a signal including the transmission ID.

Thereby, as compared with a case in which the concealment mode is constantly used or a case in which the concealment mode is selectively used by collectively selecting the concealment mode in the pair of the two authorized ECUs 20, it is possible to improve a concealment property of communication under control according to a use situation of the vehicle by selecting the concealment mode for each set of the two authorized ECUs 20 and selectively using the concealment mode.

According to at least one embodiment described above, the communication system is a communication system including a plurality of communication devices connected to a common communication bus, wherein the plurality of communication devices include: at least one set of two authorized communication devices configured to transmit a signal including first identification information and receive a signal including the first identification information. Thereby, the communication system can conceal a communication signal with a simpler configuration.

Although modes for carrying out the present invention have been described above using the embodiments, the present invention is not limited to the embodiments and various modifications and replacements can be applied without departing from the scope of the present invention.

What is claimed is:

1. A communication system including a plurality of communication devices connected to a common communication bus,
wherein the plurality of communication devices include:
at least one set of two authorized communication devices configured to transmit a signal including first identification information and receive a signal including the first identification information.

2. The communication system according to claim 1, wherein the communication devices belonging to the set transmit the signal including the first identification information and receive the signal including the first identification information if communication from an external device different from the communication devices connected to the common communication bus is detected.

3. The communication system according to claim 1, wherein the number of sets is increased if communication from an external device different from the communication devices connected to the common communication bus is detected.

4. The communication system according to claim 1, wherein the communication devices belonging to the set transmit information of different properties as the signal including the first identification information.

5. The communication system according to claim 1, wherein communication devices belonging to a plurality of different sets use the first identification information differing according to each belonging set.

6. The communication system according to claim 1, wherein the first identification information indicates that the signal including the first identification information should be received.

7. The communication system according to claim 1, wherein the first identification information indicates a transmission source of the transmitted signal.

8. The communication system according to claim 1, wherein the first identification information is associated with information related to a control operation.

9. The communication system according to claim 1, wherein a property of information to be transmitted by one communication device belonging to the set as the signal including the first identification information is different from a property of information to be received by the communication device as the signal including the first identification information.
